(19) United States
(12) Patent Application Publication
(10) Pub. No.: US 2008/0143027 A1
(43) Pub. Date: Jun. 19, 2008

(54) Top cap crimping for air spring suspension

(75) Inventor: Luc Knevels, Sint-Truiden (BE)

Correspondence Address: HARNESS, DICKEY & PIERCE, P.L.C., P.O. BOX 828, BLOOMFIELD HILLS, MI, 48303, US

(73) Assignee: Tenneco Automotive Operating Company Inc., Lake Forest, IL (US)

(21) Appl. No.: 11/639,111

(22) Filed: Dec. 14, 2006

(51) Int. Cl. F16F 5/00

(52) U.S. Cl. 267/64.11; 267/64.27

(57) ABSTRACT

A vehicle suspension strut and air spring combination having a simplified means of attaching and sealing the upper end of the air suspension sleeve around the strut is provided, wherein an inner ring is placed within the upper end of the resilient air spring sleeve, and a cap for attaching the air spring sleeve to the extendable strut rod receiving the inner ring and upper end of the spring sleeve. The cap is subsequently crimped, retaining and sealing the upper end of the air spring sleeve between the inner ring and the cap. The sealed assembled end yields fewer parts for assembly as well as a clear upper outer surface of the cap, decreasing the risk for sources of corrosion to collect.

### FIELD OF THE INVENTION

The present invention relates to air-suspension for motor vehicle cabins. More particularly, the present invention relates to a new air seal which seals the compressed air located within an air spring associated with the suspension of a motor vehicle cabin.

### BACKGROUND OF THE INVENTION

MacPherson struts are being employed in many present day vehicles and are being designed into many future vehicles. These struts comprise a combination of suspension spring and shock absorber which are utilized in many vehicle applications, including the cabin suspension for a truck. A typical strut includes the suspension spring positioned coaxially around the shock absorber. The spring extends from a bracket mounted on the outer tube of the shock absorber to a bracket that is integrated into the top mounting system for the strut. The suspension spring typically comprises a resilient air bellow or sleeve which is pressurized with air, thereby providing the suspending element of the assembly.

When an air spring assembly is used in a cabin suspension application, the air spring assembly is positioned coaxially over the shock absorber assembly which provides the damping for the assembly, and is attached to the vehicle cabin (sprung mass) through the top mounting system for the shock absorber.

Regardless of which type of mounting system is utilized to attach the air spring assembly to the vehicle cabin, it is absolutely necessary to maintain a sealed pressure chamber within the air spring assembly itself. The pressurized air within the air spring assembly supports the sprung mass of the cabin. Thus, there is a need to adequately seal the air spring assembly both at the interface with the upper mounting system as well as the interface with the shock absorber in the strut suspension system.

The continued development of strut suspension systems incorporating air spring assemblies concentric with the shock absorber includes the development of a sealing system which seals the pressurized chamber for the upper air spring assembly, in a simple, strong, and economical method.

### SUMMARY OF THE INVENTION

The present invention provides a sealing system which comprises sealing the upper support interface between the air spring assembly and the strut assembly top cap. This system provides the economical, reliable solution to prevent air leakage from the air spring assembly to the outside environment around the strut.

An additional object of the present invention is to provide a clear upper support surface that, once sealed, prevents air spring roll-up when under load.

A further object of the present invention is to provide a secured means of attaching the suspension air sleeve to the upper top cap with minimal manufacturing resources.

A further object of the present invention is to provide a secure and economically manufactured upper-seal retention means between the top cap and the strut rod.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial cross sectional side view of a cabin suspension assembly having an air spring assembly positioned co-axially over the shock absorber assembly;

FIG. 2 is a partial cross sectional side view of the upper sealing means between a top cap and the air spring assembly;

FIG. 3 is a cross sectional view of the assembly progression illustrating the upper sealing means between a top cap and the air spring assembly; and

FIG. 4 is a cross sectional view of the upper sealing means of the top cap and the strut rod.

### DETAILED DESCRIPTION OF THE PREFERRED EMBODIMENTS

The following description of the preferred embodiment(s) is merely exemplary in nature and is in no way intended to limit the invention, its application, or uses.

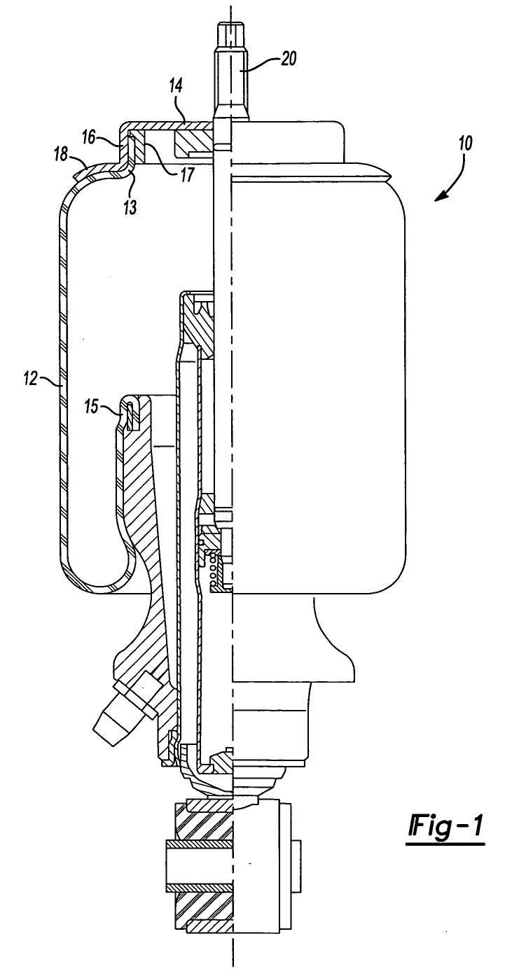

Referring to the drawings, specifically FIG. 1, a suspension strut having an air spring assembly 10 positioned co-axially over the strut assembly is shown. The air spring assembly 10 comprises the inner strut rod 20 component of the shock absorber, a resilient rubber air suspension sleeve 12 having a lower sealing end 15, and an upper sealing end 13.

The lower sealing end 15 is sealed to the strut body by means of a clamping means known in the art, which provides a continuous air tight seal between air suspension sleeve 12 and the strut body through the actuation of the strut and air suspension sleeve 12, with the air suspension sleeve convoluting over itself during periods of partial or full suspension compression as shown.

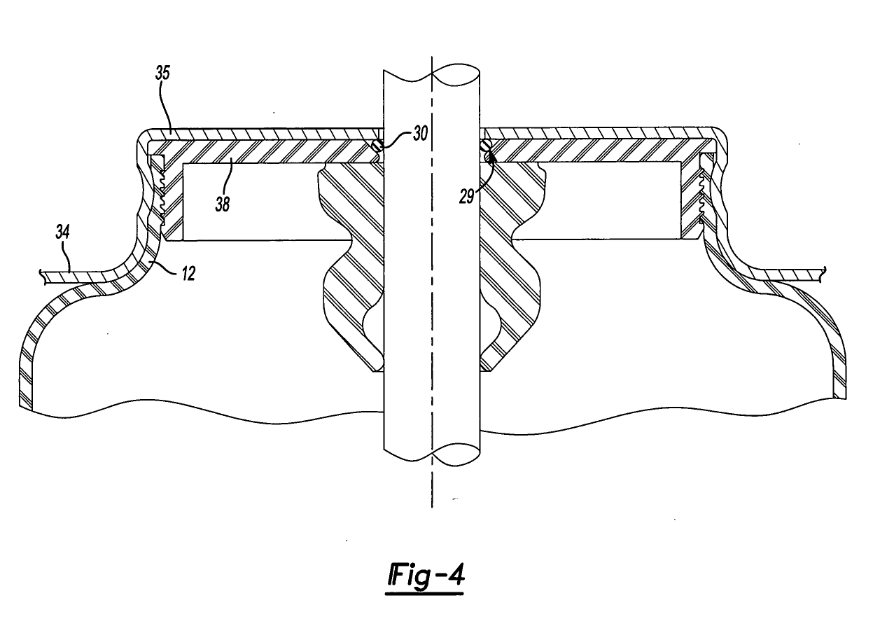

The upper sealing means, described in detail further on, comprises a top cap 14 which attaches to the strut rod 20, an inner crimp ring 17 around which the upper sealing end 13 of the air suspension sleeve is positioned. The top cap is then compressed around the upper sealing end 13, forming outer sealing wall 16 and flange 18. The details will be further explained in FIGS. 4 and 5 discussed herein.

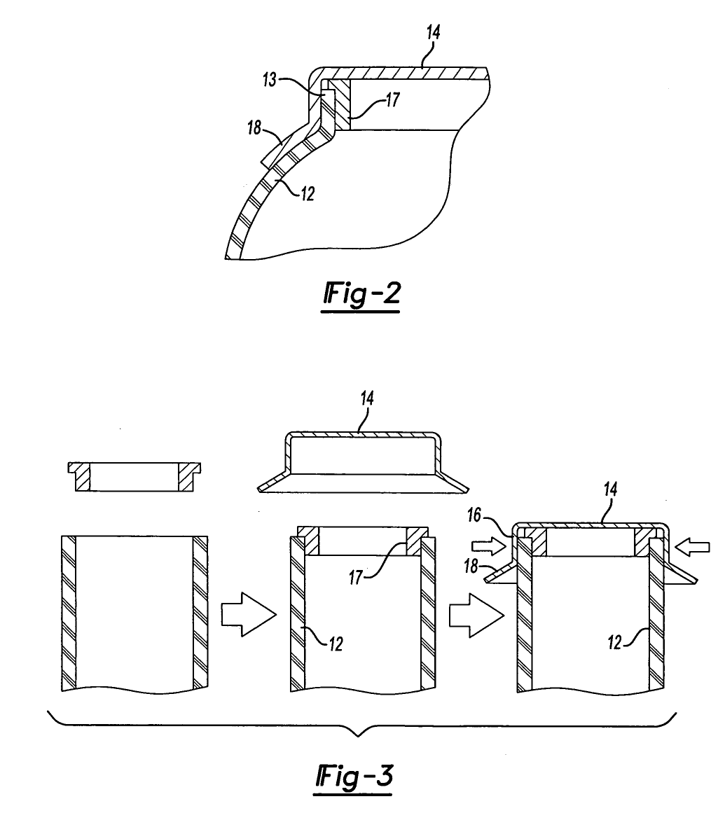

Referring to FIGS. 2 and 3 collectively, the preferred embodiment of the present invention is shown, comprising the improved sealing means of the top cap 14 to the air suspension sleeve 12. Specifically, FIG. 2 illustrates the fully assembled top cap sealing means having the top cap 14 assembled around the upper sealing end 13 of the air suspension sleeve 12. In assembling the upper sealing means as illustrated in FIG. 3, the flanged inner crimp ring 17 is positioned in the upper sealing end 13 of the deflated air suspension sleeve 12. The small annular flange prevents the crimp ring from falling into the suspension sleeve during assembly. The top cap 14 is then positioned over the upper end of the air suspension sleeve 12 and inner crimp ring 17 so that the outer sealing wall 16 of the top cap 14 retains the upper end of the suspension sleeve 12 between the inner surface of the outer sealing wall 16 and the outer surface of the inner crimp ring 17.

The outer sealing wall 16 of the top cap 14 is subsequently compressed or crimped in a conventional way utilizing uniform circumferential force on the outside surface of the sealing wall 16, while retaining the outward flared flange 18 so as to provide a limiting barrier for the inflated air suspension sleeve 12 under significant load usage. The crimping of the outer sealing wall 16 compresses and retains the upper end of the suspension sleeve 12 against the inner crimp ring 17, providing a permanent, air tight seal which allows for the inflation of the suspension sleeve once installed on a vehicle. As mentioned, the assembly provides a clean upper surface with no seams decreasing the risk for sources of corrosion, as well as significantly simplifying the manufacturing process.

Referring now to FIG. 4, a further embodiment of the present invention is shown, pertaining to the sealing means between the top cap 35 and the strut rod 20. Specifically, the top cap 35 in this embodiment illustrates a central aperture through which the strut rod 20 is positioned, and embodies the flared outer flange 34 which provides a limiting barrier for the inflated air suspension sleeve 12 under significant load usage. Similar to the previously described embodiment, the top cap 35 compresses and retains the upper end of the suspension sleeve 12 against a plastic inner support 38, providing a permanent, air tight seal which allows for the inflation of the suspension sleeve once installed on a vehicle.

The inner support 38 further comprises a central aperture through which the strut rod 20 is positioned, and features a beveled inner radius 29 around the strut rod aperture. Once assembled, the pressure inside the air spring pushes the inner support 38 flush against the bottom surface of the top cap 35, wherein the beveled inner radius 29 provides a small gap which contains a sealing o-ring 30, clamped and secured there between, around the strut rod 20. This provides for the permanent retention of the o-ring, while maintaining proper sealing means around the strut rod 20.

The description of the invention is merely exemplary in nature and, thus, variations that do not depart from the gist of the invention are intended to be within the scope of the invention. Such variations are not to be regarded as a departure from the spirit and scope of the invention.

1. An air spring assembly comprising:
a strut assembly having an upper extendable rod and a lower damper portion;
a resilient air suspension sleeve, having an upper end, a lower end, an outer surface and an inner surface, said sleeve positioned around said strut assembly, yielding a chamber;
lower sealing means, for providing an air tight seal between said lower end of said air suspension sleeve and said lower damper portion of said strut assembly; and
upper sealing means for providing an air tight seal between said upper end of the air suspension sleeve and said upper extendable rod of said strut assembly, yielding a sealed chamber between said strut assembly and said air suspension sleeve;
wherein said upper sealing means comprises a cap sealingly attached around said extendable rod of said strut assembly, said extendable rod of said strut assembly extending through an aperture defined by said cap, said cap having an annular outer wall parallel to said extendable rod, sealingly retaining the upper end of said air suspension sleeve radially inward towards said extendable rod.

2. The air spring assembly of claim 1 wherein said upper sealing means comprises an inner crimp support ring positioned partially within the upper end of said air suspension sleeve, sealingly retaining said upper end of the air suspension sleeve against the annular outer wall of said cap.

3. The air spring assembly of claim 2 wherein said inner crimp support ring comprises a radial flange having an outside diameter greater than an inside diameter of the upper end of said air suspension sleeve.

4. The air spring assembly of claim 2 wherein said cap radially surrounds both the inner crimp support ring and the upper portion of the air suspension sleeve.

5. The air spring assembly of claim 4 wherein rod sealing means is clamped between the inner crimp support ring, the cap and the upper extendable rod.

6. The air spring assembly of claim 5 wherein said cap further comprises an outward flanged end.

7. (canceled)

8. A method of providing upper sealing means for sealing the upper end of a resilient air spring having an air spring sleeve to an inner strut assembly having an extendable strut rod comprising the steps of:
positioning an inner crimp support ring partially in an upper end of said air spring sleeve;
placing an upper cap having an annular outer wall and a central aperture for receiving the extendable strut rod of the inner strut assembly therethrough over the upper end of the air spring sleeve and the installed inner crimp support ring;
applying circumferential crimping force around the annular outer wall of the upper cap, pinching and sealing the upper end of the air spring sleeve between the annular outer wall of the upper cap, and the inner crimp support ring;
placing the air spring sleeve co-axially over the inner strut assembly, extending the extendable strut rod through the control aperture in the upper cap and attaching and sealing the upper cap around the extendable strut rod of the inner strut assembly;
attaching and sealing a lower end of the air spring sleeve to the inner strut assembly; and
pressurizing an air space between the air spring sleeve and the inner strut assembly to a predetermined pressure.

9. The air spring assembly of claim 2 wherein both the cap and the inner crimp support ring extend continuously from the air suspension sleeve to the extendable rod.

10. The air spring assembly of claim 9 wherein gas pressure within the sealed chamber urges the inner crimp support ring axially towards the cap.

11. The air spring assembly of claim 2 further comprising a seal engaging the inner crimp support ring, the extendable rod and the cap.

12. The air spring assembly according to claim 2 wherein the inner crimp support ring includes a disk portion defining an aperture through which the extendable rod extends and an annular portion attached to the disc portion which sealingly engages the upper end of the air suspension sleeve, the disk portion extending radially inward from the annular portion.

13. The air spring assembly according to claim 2 further comprising a seal engaging the inner crimp support ring and the upper extendable rod to seal an end face of said resilient air suspension sleeve from said sealed chamber.

14. The air spring assembly according to claim 1 further comprising a seal engaging said upper seal means and said upper extendable rod to seal an end face of said resilient air suspension sleeve from said sealed chamber.
